(19) United States
(12) Patent Application Publication
(10) Pub. No.: US 2026/0037734 A1
(43) Pub. Date: Feb. 5, 2026

(54) SYSTEMS AND METHODS FOR CONFIGURING DATA USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Jyothi Gaddam, Hyderabad (IN); Venugopala Rao Randhi, Hyderabad (IN); Rama Venkata Kavali, Frisco, TX (US); Manohar Aedma, Simi Valley, CA (US)

(73) Assignee: BANK OF AMERICA CORPORATION, CHARLOTTE, NC (US)

(21) Appl. No.: 18/794,701

(22) Filed: Aug. 5, 2024

(51) Int. Cl. G06F 40/30; G06F 21/62

(52) U.S. Cl. CPC G06F 40/30; G06F 21/6245

(57) ABSTRACT

Systems, computer program products, and methods are described herein for configuring data using advanced computational models for data analysis and automated processing. The present disclosure is configured to train a large language model (LLM), wherein training the LLM comprises using system-specific data comprising feed data, process run logs, historical events, code base, existing permissions, and data classification rules. The present disclosure is configured to determine prone data, wherein the prone data comprises a log file comprising sensitive information, and wherein the prone data is determined via a prone module. The present disclosure is configured to configure the prone data using a generative artificial intelligence (GenAI) module, wherein the GenAI module configures the prone data by masking the sensitive information using a masking procedure. The present disclosure is configured to determine the masking procedure via a decentralized autonomous organization (DAO).

### TECHNOLOGICAL FIELD

Example embodiments of the present disclosure relate to configuring data using advanced computational models for data analysis and automated processing.

### BACKGROUND

There are significant challenges associated with securitization of log files. Applicant has identified a number of deficiencies and problems associated with configuring log files in conventional systems. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for configuring data using advanced computational models for data analysis and automated processing.

Embodiments of the present invention address the above needs and/or achieve other advantages by providing apparatuses (e.g., a system, computer program product, and/or other devices) and methods for configuring data using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure may train a large language model (LLM), wherein training the LLM includes using system-specific data comprising feed data, process run logs, historical events, code base, existing permissions, and data classification rules. In some embodiments, the present disclosure may determine prone data, wherein the prone data includes a log file including sensitive information, and wherein the prone data is determined via a prone module. In some embodiments, the present disclosure may configure the prone data using a generative artificial intelligence (GenAI) module, wherein the GenAI module configures the prone data by masking the sensitive information using a masking procedure. In some embodiments, the present disclosure may determine the masking procedure via a decentralized autonomous organization (DAO).

In some embodiments, the GenAI module may configure the prone data by ingesting the system-specific data, understanding, via the prone module, the sensitive data within the prone data via a natural language processing module, and configuring the prone data, the log file, and the sensitive information using the masking procedure.

In some embodiments, the masking procedure includes creating a generalized message, wherein the generalized message configures the prone data by replacing the sensitive information with the generalized message.

In some embodiments, the masking procedure includes concealing the sensitive information of the prone data by replacing the sensitive information with one or more symbols.

In some embodiments, the masking procedure includes transferring the prone data to a secured location, wherein the secured location includes permission-based access restrictions.

In some embodiments, the masking procedure includes analyzing the prone data to determine the sensitive information, structuring the prone data, and concealing the sensitive information of the prone data by replacing the sensitive information with one or more symbols.

In some embodiments, the DAO includes executing a smart contract, wherein the smart contract transmits the masking procedure to one or more stakeholders. In some embodiments, the DAO includes receiving an approval from the one or more stakeholders, wherein the approval approves the masking procedure. In some embodiments, the DAO includes implementing the masking procedure into a production-level GenAI module.

In some embodiments, the DAO includes executing a smart contract, wherein the smart contract transmits the masking procedure to one or more stakeholders. In some embodiments, the DAO includes receiving a rejection from the one or more stakeholders, wherein the rejection rejects the masking procedure. In some embodiments, the DAO includes generating one or more reports detailing the rejection of the masking procedure. In some embodiments, the DAO includes refining the masking procedure via the LLM to create an updated masking procedure. In some embodiments, the DAO includes configuring, via the GenAI module, the prone data by masking the sensitive data using the updated masking procedure.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for configuring data using advanced computational models for data analysis and automated processing, in accordance with an embodiment of the disclosure;

FIG. 2 illustrates an exemplary machine learning (ML) subsystem architecture 200, in accordance with an embodiment of the disclosure;

FIG. 3 illustrates a process flow for configuring data using advanced computational models for data analysis and automated processing, in accordance with an embodiment of the disclosure;

FIG. 4 illustrates an exemplary embodiment of the system, in accordance with an embodiment of the disclosure; and

FIG. 5 illustrates example embodiments of masking procedures, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, a “module” may refer to core elements of an application, or part of an application that serves as a foundation for a larger piece of software and drives the functionality of the software. In some embodiments, a module may be self-contained, but externally-controllable code that encapsulates powerful logic designed to perform or execute a specific type of function. In one aspect, a module may be underlying source code that establishes file hierarchy, input and output methods, and how a specific part of an application interacts or communicates with other software and/or hardware. The specific components of a module may vary based on the needs of the specific application as part of the larger piece of software. In some embodiments, a module may be configured to retrieve resources created in other applications, which may then be ported into the module for use during specific operational aspects of the module. A module may be configurable to be implemented within any general purpose computing system. In doing so, the module may be configured to execute source code embedded therein to control specific features of the general purpose computing system to execute specific computing operations, thereby transforming the general purpose system into a specific purpose computing system

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In modern a computing environment, log files and/or log data provide detailed information associated with events, transactions, and users interaction with the computing environment. Log data includes the records of all the events occurring in a system, application, network device, user device, end-point device, or the like. When logging is enabled, log files are automatically generated by the system. Further, the system may timestamp the log files to provide information as to when the log file was created. In addition, the log files provide information pertaining to who was part of an event, when the event occurred, where the event occurred, and how the event occurred or was handled.

In conventional systems, however, log files may reveal information that should otherwise be hidden (e.g., sensitive information). This is the case when log files are created surrounding data with sensitive information. For example, a user may submit to a system the user's sensitive information. A conventional system may reproduce the user's sensitive information during log file generation. In this example, the user's sensitive information may, through the log file, be exposed to individuals without permission to view the user's information. In a specific example, this may happen when a system receives another user's sensitive information that is the same as the first user's information. When a conventional system receives duplicated information, the system may produce an error log file showing the duplicative information, which, in this case, may be the users' sensitive information. This may translate into conventional systems exposing a user's or users' sensitive information which may include but is not limited to social security numbers (SSNs), account numbers, dates of birth, identification numbers, credit card or debit card numbers, license numbers, passport numbers, personal identification numbers (PINs), tax identification numbers, and the like. Therefore, systems and methods for configuring data using advanced computational models for data analysis and automated processing are introduced.

The present disclosure provides for a system, computer program product, method, or the like to configure data (e.g., log files) in a way to secure sensitive information contained within the log file. The functionalities as described herein may be carried out by a system, a computer program product, or a method. In this way, the present disclosure may include a large language model (LLM) trained with feed data, code base data, data classification rules, permissions, historical events, log files, or the like. Training the LLM with this data may provide the LLM with the ability to mitigate access to feed data if sensitive information is present, modify the enterprise application code base, distinguish data among enterprise level data classification rules, mitigate user access to feed data, log files, and tables, learn from sensitive information events that have taken place previously, and evaluate log files for sensitive information. A prone module may be used to identify prone data, which may be data (e.g., a log file) that includes sensitive information. For example, prone data may include a log file that contains a user's SSN, for example. Further, a generative artificial intelligence (GenAI) module may mask the sensitive data in the log file using a masking procedure.

The masking procedure may be selected from a variety of masking procedures. The masking procedures may generally aim to remove, or at least restrict, the ability to view the sensitive information from the log file. Using the above-mentioned example where duplicative SSN information is presented to a system, the masking procedures may remove, or at least restrict, the ability for individuals to view the SSN when error log files are created. These error log files may indicate that duplicative SSN (e.g., sensitive information) has been entered. For instance, a masking procedure may configure the prone data (e.g., the log file containing the sensitive information) in such a way as to replace the SSN with a generalized message. In this way, when a log file is created, a user's SSN may be replaced with a generic system message stating duplicated information has been received, without revealing the duplicated SSN. Another masking procedure may conceal the SSN altogether, by replacing the SSN with symbols, such as asterisks, stars, or the like. Further, another option for the masking procedure is to move the prone data to a secured file location with restricted access (e.g., a password protected folder structure, or the like). Further still, the masking procedure may include creating a structured dataset (e.g., a table) of the prone data and concealing the sensitive information of the prone data.

What is more, the present disclosure provides a technical solution to a technical problem. As described herein, the technical problem includes conventional systems revealing sensitive information associated with a user during log file generation and reporting. The technical solution presented herein allows for masking the sensitive information via a masking procedure. In particular, a data configuration system (e.g., the system 130 as described herein) is an improvement over existing solutions to the issues surrounding conventional handling of log files that contain sensitive information, (i) with fewer steps to achieve the solution, thus reducing the amount of computing resources, such as processing resources, storage resources, network resources, and/or the like, that are being used (e.g., via using a GenAI module to determine the appropriate masking procedure for particular data), (ii) providing a more accurate solution to problem, thus reducing the number of resources required to remedy any errors made due to a less accurate solution (e.g., by using an LLM and prone module to determine which data should be masked via the masking procedure), (iii) removing manual input and waste from the implementation of the solution, thus improving speed and efficiency of the process and conserving computing resources (e.g., via using a GenAI module to implement code modification, testing, and execution), (iv) determining an optimal amount of resources that need to be used to implement the solution, thus reducing network traffic and load on existing computing resources (e.g., by refining the LLM to reduce wasted resources). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the data configuration system as described herein is a solution to the problem of exposing sensitive information in log files. Further, the data configuration system may be characterized as identifying a specific improvement in computer capabilities and/or network functionalities in response to the data configuration system's integration to existing devices, software, applications, and/or the like. In this way, the data configuration system improves the capability of a system to secure sensitive information within a log file through masking procedures. Further, the data configuration system improves the functionality of networks in response to reducing the resources consumed by the system (e.g., network resources, computing resources, memory resources, and/or the like).

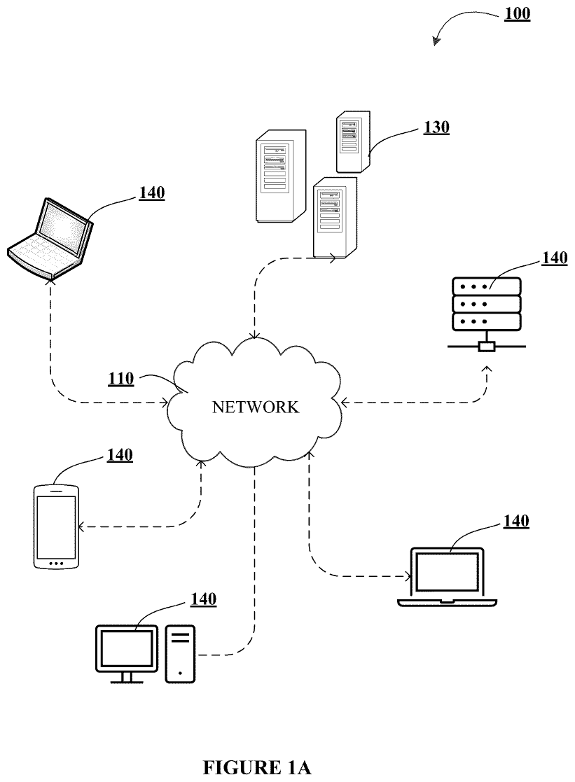

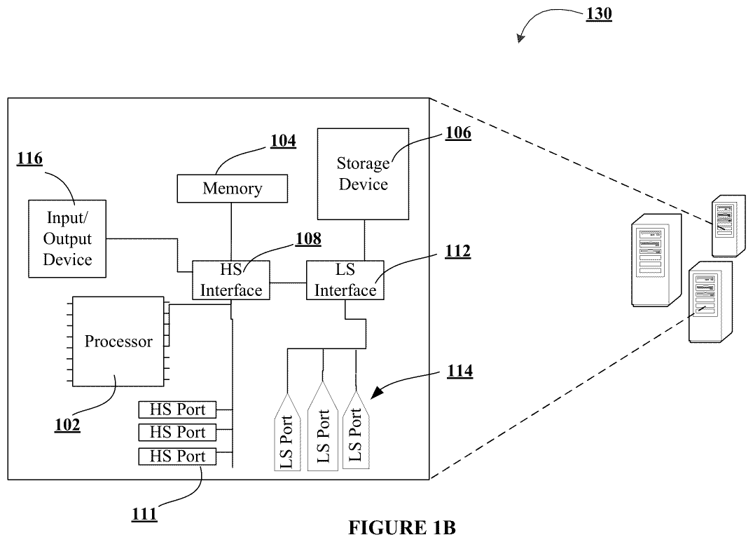

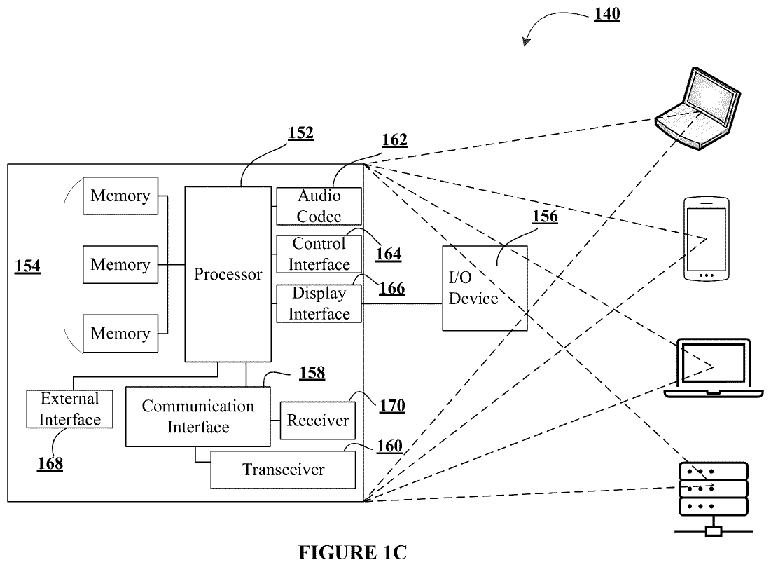

FIGS. 1A-1C illustrate technical components of an exemplary distributed computing environment 100 for configuring data using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. For example, the LLM 416, the prone module 418, and the GenAI module 420 may each include a processor similar to processor 102 or each receive instructions from processor 102. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

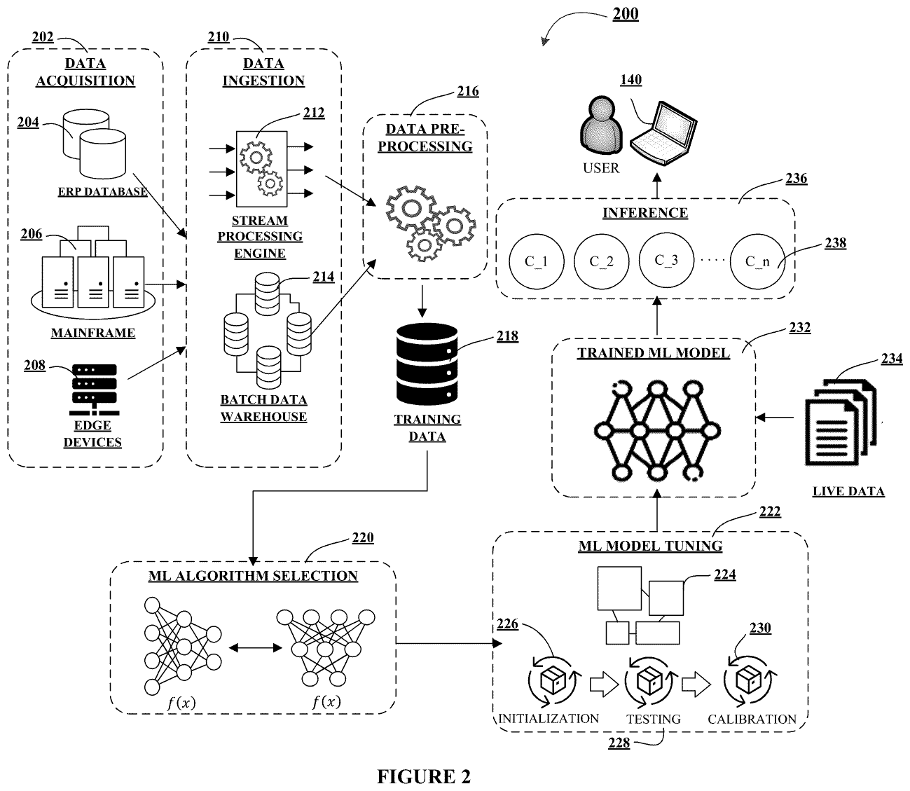

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

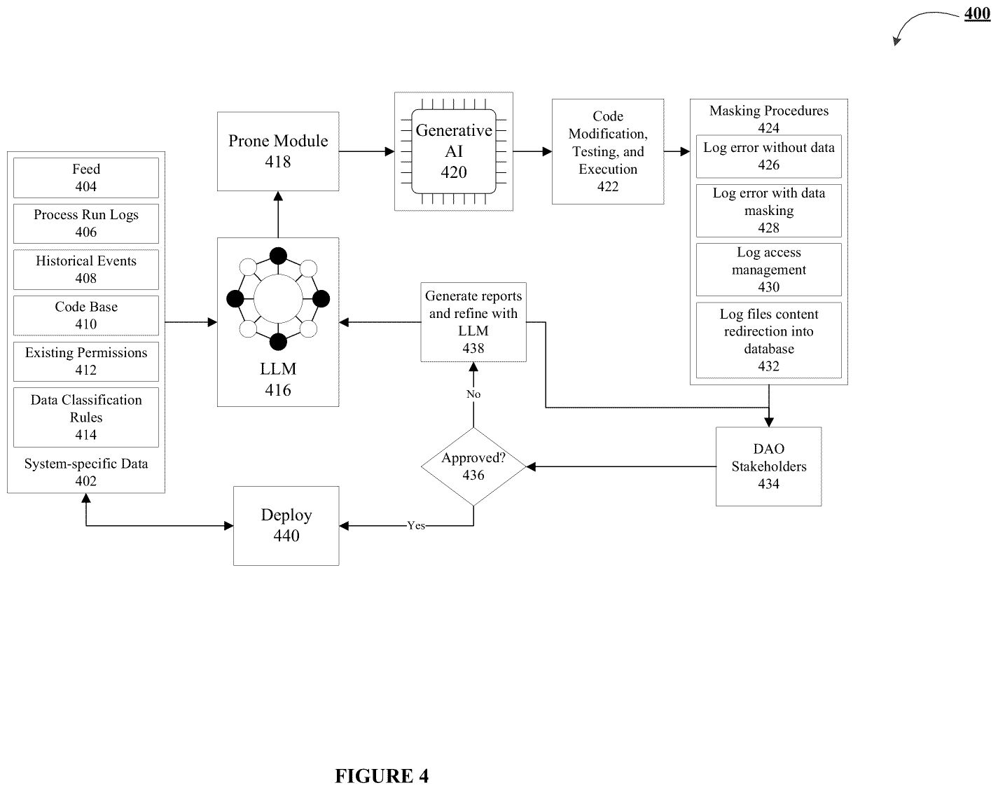

In some embodiments, and as shown in FIG. 4, the LLM 416, the prone module 418, and the generative AI (GenAI) module 420 may include the ML subsystem architecture 200. In this way, the LLM 416, the prone module 418, and the GenAI module 420 may ingest data, pre-process data, tune data, and make inferences from the data similar to the ML subsystem architecture 200 as shown in FIG. 2. Further, the LLM 416, the prone module 418, and the GenAI module 420 may include the same or similar subsystem architecture as described in FIG. 2, such as the data acquisition engine 202, data ingestion engine 210, data pre-processing engine 216, ML model tuning engine 222, and/or inference engine 236. In this way, the functionalities as described with respect to the ML subsystem architecture 200 may also be applied to the LLM 416, the prone module 418, and/or the GenAI module 420.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. In some embodiments, the LLM 416, the prone module 418, and the GenAI module 420 may receive system-specific data 402 via the data acquisition engine 202. In this way, the system-specific data 402 may be located in various internal and/or external data sources, similar to the internal and/or external data sources 204, 206, and 208 in FIG. 2. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the LLM 416, the prone module 418, the generative AI 420, or the data acquisition engine 202 from these data sources 204, 206, and 208 may then be transported to the LLM 416 or the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including relational database management systems (RDBMS), non-relational database management systems, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. For example, the LLM 416 may include a ML model tuning engine 222. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

In some embodiments, the LLM 416, the prone module 418, and the GenAI 420 may include a trained machine learning model 232. The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

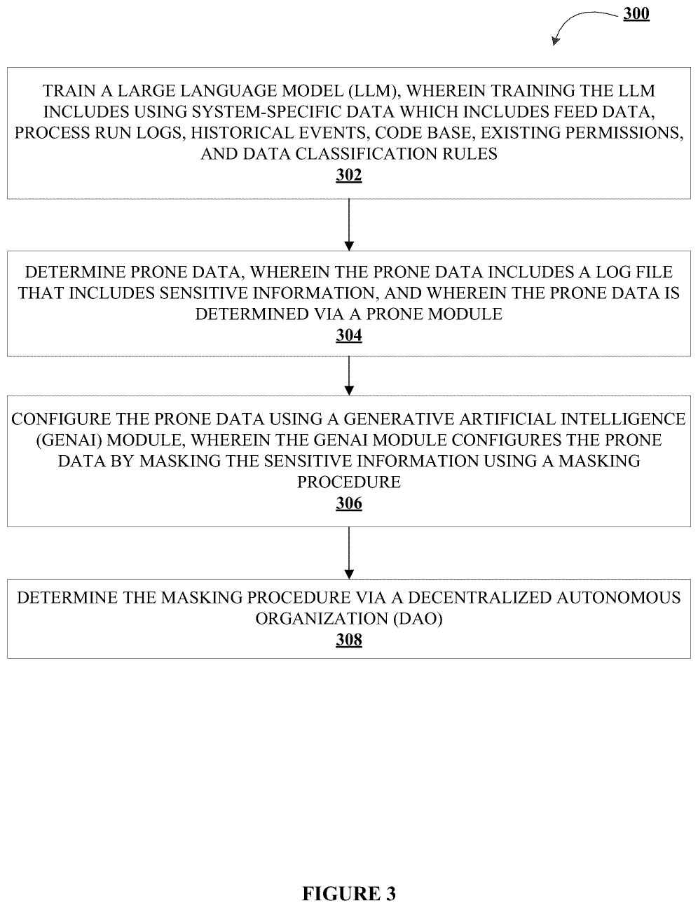

FIG. 3 illustrates a process flow for configuring data using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a data configuration system (e.g., similar to one or more of the systems described herein with respect to Figures IA-1C) may perform one or more of the steps of process flow 300. For example, a data configuration system (e.g., the system 130 described herein with respect to FIGS. 1A-1C) may perform the steps of process flow 300.

As shown in block 302 of FIG. 3, the process flow 300 of this embodiment includes training a large language model (LLM), wherein training the LLM includes using system-specific data which includes feed data, process run logs, historical events, code base, existing permissions, and data classification rules. The LLM may use the system-specific data to understand the log files, the prone data, and the sensitive information. The feed data may be used to mitigate access to feed files if any sensitive information is present. In this way, the LLM may understand which feed files contain sensitive information within the system. The LLM may use the code base data to modify the code, if needed. In this way, the LLM may use the application code base and be able to edit the application code base. Further, the data classification rules may be used to distinguish the data. In this way, the LLM may be able to differentiate levels of data by using the data classification rules when determining if sensitive information exists in a particular log file. The historical events may be used by the LLM to learn how to identify and determine sensitive information exists. Further, the process run logs may be used by the LLM to evaluate for sensitive information.

In some embodiments, and as shown in FIG. 4, the system-specific data 402 may be fed into the LLM 416. In some embodiments, the LLM 416 may components, engines, modules, and the like similar to those shown in FIG. 2 to ingest and process the system-specific data 402. Further, the LLM may use a variety of networks to identify and determine if sensitive information is included within a log file. For example, the LLM may use recurrent neural networks (RNNs), Long Short-Term Memory (LSTM) networks, Convolutional Neural Networks (CNNs), Generative Adversarial Networks (GANs), Variational Autoencoders (VAEs), and the like.

As shown in block 304 of FIG. 3, the process flow 300 of this embodiment includes determining prone data, wherein the prone data includes a log file that includes sensitive information, and where the prone data is determined via a prone module. The prone data may include sensitive information of a user, entity, business, company, or the like. For example, when the system generates a log file that includes sensitive of a user, that may be considered prone data.

As shown in FIG. 4, the prone data may be identified by the prone module 418. The prone module 418 may determine the prone data based on machine learning, natural language processing, or the like. In this way, the prone module 418 may be equipped with processes and procedures used to understand what is considered sensitive information. The prone module 418 may undergo training to be able to make the determination between what is sensitive information and what is not sensitive information. Further, the prone module 418 may be continuously tuned to better understand how to distinguish such sensitive information.

In some embodiments, the prone module 418 may be separated from the LLM 416. In some embodiments, the prone module 418 may be considered within the LLM 416. In this way, the LLM 416 may be considered to perform all the functionalities of the prone module 418.

As shown in block 306 of FIG. 3, the process flow 300 of this embodiment includes configuring the prone data using a generative artificial intelligence (GenAI) module, wherein the GenAI module configures the prone data by masking the sensitive information using a masking procedure. In some embodiments, the GenAI module configures the prone data by ingesting the system-specific data. The data may be ingested by the GenAI module 420, the prone module 418, or the LLM 416, as shown in FIG. 4. In some embodiments, the LLM 416 and/or the prone module 418 may pre-process the prone data prior to the GenAI module 420 ingesting the prone data. Further, in some embodiments, the GenAI module 420 may include components similar to or the same as the components as shown in FIG. 2. In this way, and similar to FIG. 2, the GenAI module 420 may include capabilities for data acquisition 202, data ingestion 210, data pre-processing 216, algorithm selection 220, tuning 222, and the like.

In some embodiments, the GenAI module may understand, via the prone module, the sensitive data within the prone data via a natural language processing (NLP) module. In some embodiments, the NLP module may be included within the GenAI module 420, as shown in FIG. 4. In some embodiments, the NLP module may be a standalone module operatively coupled to the network to which the remaining components of the system (e.g., the system 130) is operatively coupled.

In some embodiments, the GenAI may configure the prone data, the log file, and the sensitive information using the masking procedure. Configuring the prone data, the log file, and/or the sensitive information may include adding, editing, or deleting data from the prone data, the log file, and/or the sensitive information. In this way, and as shown in FIG. 4, the GenAI module 420 may include the ability to modify, test, and execute the code that may affect the prone data, log file, and sensitive information (as shown in block 422). In some embodiments, the GenAI module 420 may have the ability to modify underlying code that effects the output of the error logs created by the system.

The masking procedure may be selected from a variety of potential masking procedures. The potential masking procedures may have a goal of hiding, masking, concealing, obscuring, or disguising the sensitive information. For example, the sensitive information in a particular scenario may include an account number of a user. The masking procedures may all configure the log file associated with the sensitive information in such a way as to mask, obscure, conceal, or the like the sensitive information. In this way, the masking of the sensitive information may hide the sensitive data from being shown to an individual or entity that does not have access to view the sensitive information. As compared to a conventional system where unauthorized personnel, for example, may have access to the sensitive information in a log file, the present disclosure provides for masking the sensitive information in way where the unauthorized personnel cannot view the sensitive information.

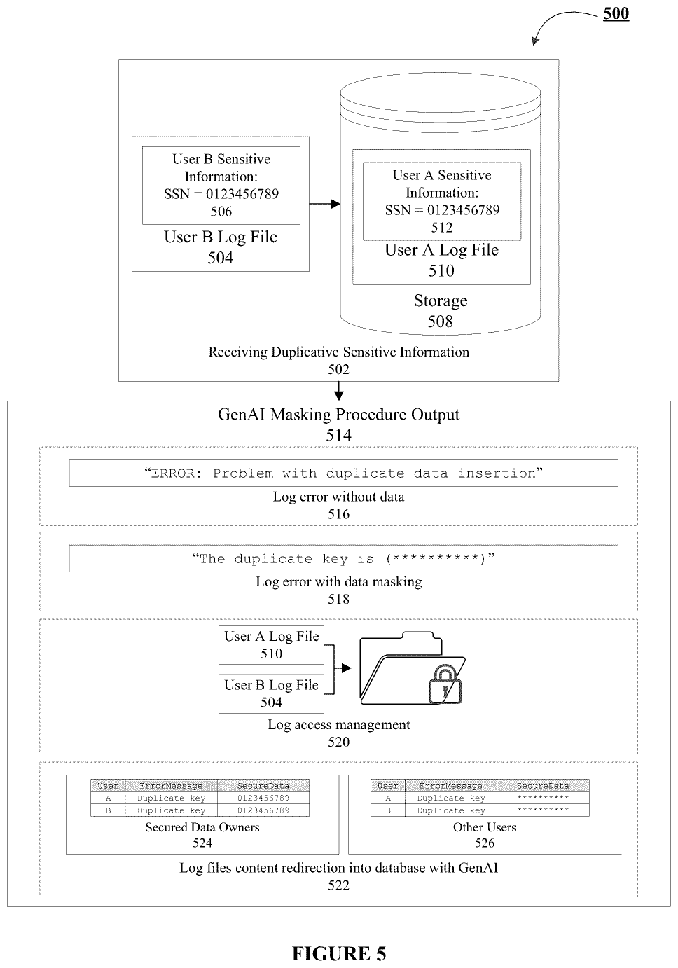

As shown in FIG. 5, the system may receive duplicative sensitive information 502. The system may already have stored User A's sensitive information which, for example, may be an account number of 0123456789 as shown in block 512. The storage 508 may be the same or similar to the memory 104 or storage device 106 as shown in FIG. 1B. The system may then receive User B's sensitive information, which may also be an account number of 0123456789, as shown in block 506. In this way, the account numbers (e.g., sensitive information) of both User A and User B may be identical. Receiving two identical account numbers, for example, may cause an error that needs to be addressed before proceeding. Further, reports, log files, messages, or the like may be generated that indicate the error and report out the details of the error. Conventional systems, in reporting out the duplicate account numbers, may expose the sensitive information of User A and User B because of the lack of ability to mask such sensitive information. However, the present disclosure provides for the system (e.g., the system 130 as described herein) to mask the sensitive information before it is reported out in a log file containing the error. This is shown in block 514 of FIG. 5 and described in more detail below.

In some embodiments, the masking procedure may include creating a generalized message, wherein the generalized message configures the prone data by replacing the sensitive information with the generalized message. For instance, the masking procedure may include creating a log error without data 516 as shown in FIG. 5. As opposed to the system outputting the sensitive information, the system's error message may state a generalized or generic message indicating that there is a problem with the data insertion. The Gen AI module 420 as shown in FIG. 4 may modify the error log file via the masking procedures 424. In some embodiments, the GenAI module 420 may choose to create the log error without data 426. For example, as shown in block 516 of FIG. 5, the error produced may state “ERROR: Problem with duplicate data insertion.”

In some embodiments, the masking procedure may include concealing the sensitive information of the prone data by replacing the sensitive information with one or more symbols. In this way, the system may generate an error message that replaces the sensitive information with symbols, characters, or the like. The symbols may include asterisks, stars, dashes, or the like that replace the characters of the sensitive information. As shown in FIG. 4, the GenAI module 420 may choose to create a log error with data masking 428. Further, as shown in FIG. 5, the log error with data masking 528 may create a message that includes “The duplicate key is (**********).” In this way, the sensitive information may be replaced with asterisks. For example, the User A and User B sensitive information (e.g., blocks 506 and 512) may be replaced with asterisks by the GenAI module 420 rather than showing the actual account numbers in the log error file.

In some embodiments, the masking procedure may include transferring the prone data to a secured location, wherein the secured location includes permission-based access restrictions. As shown in FIG. 4, the GenAI module 420 may choose to configure the log access management 430. In this way, the GenAI module 420 may set up or edit a folder structure or the like to create a restricted access location in which the log error files are transferred. In some embodiments, this may include moving the log files to the secured folder. For example, as shown in FIG. 5, the GenAI masking procedure output 514 may include configuring the log access management 520. The GenAI module 420 may create a secured folder where the User A log file 510 and the User B log file 504 will be stored. Further, the log error file may also be stored in the secured folder. The GenAI module 420 may create permission based access restrictions to specified users, individuals, stakeholders, entities, or the like. The individuals or entities with access may then be able to view, retrieve, configure, edit, delete, and the like the log files within the secured folder.

In some embodiments, the masking procedure may include analyzing the prone data to determine the sensitive information, structuring the prone data, and concealing the sensitive information of the prone data by replacing the sensitive information with one or more symbols. As shown in FIG. 4, the GenAI module 420 may select a masking procedure 424 that includes creating a database based on the log files content, as shown in block 432. As shown in FIG. 5, creating this database (shown in block 522) may include sharing access to secure data owners 524 while restricting access or hiding sensitive information from other users 526. The creation of the structured dataset may include creating a table based on the information of the log file(s). For example, the User A log file 510 and the User B log file 504 may be configured to be placed into a structured format (e.g., a table) showing the relevant information from each log file. The GenAI module 420 may scan the respective log files to determine which information should be placed into the table. For the secured data owners 524, the secure data or sensitive information may be viewable due to their permissions. For the other users 526, the secured data may be obfuscated through concealing the secured data with symbols (as shown in FIG. 5), or a generalized message, as discussed above.

As shown in block 308 of FIG. 3, the process flow 300 of this embodiment includes determining the masking procedure via a decentralized autonomous organization (DAO). In some embodiments, the DAO may include executing a smart contract, wherein the smart contract transmits the masking procedure to one or more stakeholders. In some embodiments, the DAO may receive an approval from the one or more stakeholders, wherein the approval approves the masking procedure. In some embodiments, the DAO may implement the masking procedure into a production-level GenAI module. For example, as shown in FIG. 4, the DAO stakeholders 434 may determine that the masking procedure 424 selected by the GenAI module 420 is acceptable. In this way, the DAO stakeholders 434 may approve 436 the masking procedure 424. Further, when the masking procedure is determined (i.e., approved), the system may deploy 440 the masking procedure into a production level GenAI module. The production level GenAI module may use the system-specific data 402 and the chosen masking procedure 424 to mask the sensitive information during reporting of log errors, and the like.

In some embodiments, the DAO may include receiving a rejection from the one or more stakeholders, wherein the rejection rejects the masking procedure. In some embodiments, the DAO may generate one or more reports detailing the rejection of the masking procedure. In some embodiments, the DAO may include refining the masking procedure via the LLM to create an updated masking procedure. In some embodiments, the DAO may configure, via the GenAI module, the prone data by masking the sensitive data using the updated masking procedure.

As shown in FIG. 4, the DAO stakeholders 434 may choose to reject the specified masking procedure 424. In this case, the approval will be denied (as shown in 436) and the system may generate reports and refine the procedure with the LLM 438. The reports may detail the chosen masking procedure and the process the GenAI module 420 used to choose the masking procedure 424. In this way, the decisions by the LLM 416, the prone module 418, and the GenAI module 420 may be used to create the report. Further, the LLM 416, the prone module 418, and the GenAI module 420 may be refined. The refinement may be based on the DAO stakeholders 434 input which may provide more direction for the GenAI 420 module to create the updated masking procedure.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for configuring data using advanced computational models for data analysis and automated processing, the system comprising:
a processing device;
a non-transitory storage device containing instructions when executed by the processing device, causes the processing device to perform the steps of:
train a large language model (LLM), wherein training the LLM comprises using system-specific data comprising feed data, process run logs, historical events, code base, existing permissions, and data classification rules;
determine prone data, wherein the prone data comprises a log file comprising sensitive information, and wherein the prone data is determined via a prone module;
configure the prone data using a generative artificial intelligence (GenAI) module, wherein the GenAI module configures the prone data by masking the sensitive information using a masking procedure; and
determine the masking procedure via a decentralized autonomous organization (DAO).

2. The system of claim 1, wherein the GenAI module configures the prone data by:
ingesting the system-specific data;
understanding, via the prone module, the sensitive data within the prone data via a natural language processing module; and
configuring the prone data, the log file, and the sensitive information using the masking procedure.

3. The system of claim 1, wherein the masking procedure comprises creating a generalized message, wherein the generalized message configures the prone data by replacing the sensitive information with the generalized message.

4. The system of claim 1, wherein the masking procedure comprises concealing the sensitive information of the prone data by replacing the sensitive information with one or more symbols.

5. The system of claim 1, wherein the masking procedure comprises transferring the prone data to a secured location, wherein the secured location comprises permission-based access restrictions.

6. The system of claim 1, wherein the masking procedure comprises:
analyzing the prone data to determine the sensitive information;
structuring the prone data; and
concealing the sensitive information of the prone data by replacing the sensitive information with one or more symbols.

7. The system of claim 1, wherein the DAO comprises:
executing a smart contract, wherein the smart contract transmits the masking procedure to one or more stakeholders;
receiving an approval from the one or more stakeholders, wherein the approval approves the masking procedure; and
implementing the masking procedure into a production-level GenAI module.

8. The system of claim 1, wherein the DAO comprises:
executing a smart contract, wherein the smart contract transmits the masking procedure to one or more stakeholders;
receiving a rejection from the one or more stakeholders, wherein the rejection rejects the masking procedure;
generating one or more reports detailing the rejection of the masking procedure;
refining the masking procedure via the LLM to create an updated masking procedure; and
configuring, via the GenAI module, the prone data by masking the sensitive data using the updated masking procedure.

9. A computer program product for configuring data using advanced computational models for data analysis and automated processing, the computer program product comprising a non-transitory computer-readable medium comprising code causing an apparatus to:
train a large language model (LLM), wherein training the LLM comprises using system-specific data comprising feed data, process run logs, historical events, code base, existing permissions, and data classification rules;
determine prone data, wherein the prone data comprises a log file comprising sensitive information, and wherein the prone data is determined via a prone module;
configure the prone data using a generative artificial intelligence (GenAI) module, wherein the GenAI module configures the prone data by masking the sensitive information using a masking procedure; and
determine the masking procedure via a decentralized autonomous organization (DAO).

10. The computer program product of claim 9, wherein the GenAI module configures the prone data by:
ingesting the system-specific data;
understanding, via the prone module, the sensitive data within the prone data via a natural language processing module; and
configuring the prone data, the log file, and the sensitive information using the masking procedure.

11. The computer program product of claim 9, wherein the masking procedure comprises creating a generalized message, wherein the generalized message configures the prone data by replacing the sensitive information with the generalized message.

12. The computer program product of claim 9, wherein the masking procedure comprises concealing the sensitive information of the prone data by replacing the sensitive information with one or more symbols.

13. The computer program product of claim 9, wherein the masking procedure comprises transferring the prone data to a secured location, wherein the secured location comprises permission-based access restrictions.

14. The computer program product of claim 9, wherein the masking procedure comprises:
analyzing the prone data to determine the sensitive information;
structuring the prone data; and
concealing the sensitive information of the prone data by replacing the sensitive information with one or more symbols.

15. The computer program product of claim 9, wherein the DAO comprises:
executing a smart contract, wherein the smart contract transmits the masking procedure to one or more stakeholders;
receiving an approval from the one or more stakeholders, wherein the approval approves the masking procedure; and
implementing the masking procedure into a production-level GenAI module.

16. The computer program product of claim 9, wherein the DAO comprises:
executing a smart contract, wherein the smart contract transmits the masking procedure to one or more stakeholders;
receiving a rejection from the one or more stakeholders, wherein the rejection rejects the masking procedure;
generating one or more reports detailing the rejection of the masking procedure;
refining the masking procedure via the LLM to create an updated masking procedure; and
configuring, via the GenAI module, the prone data by masking the sensitive data using the updated masking procedure.

17. A method for configuring data using advanced computational models for data analysis and automated processing, the method comprising:
training a large language model (LLM), wherein training the LLM comprises using system-specific data comprising feed data, process run logs, historical events, code base, existing permission, and data classification rules;
determining prone data, wherein the prone data comprises a log file comprising sensitive information, and wherein the prone data is determined via a prone module;
configuring the prone data using a generative artificial intelligence (GenAI) module, wherein the GenAI module configures the prone data by masking the sensitive information using a masking procedure; and
determining the masking procedure via a decentralized autonomous organization (DAO).

18. The method of claim 17, wherein the GenAI module configures the prone data by:
ingesting the system-specific data;
understanding, via the prone module, the sensitive data within the prone data via a natural language processing module; and
configuring the prone data, the log file, and the sensitive information using the masking procedure.

19. The method of claim 17, wherein the masking procedure comprises creating a generalized message, wherein the generalized message configures the prone data by replacing the sensitive information with the generalized message.

20. The method of claim 17, wherein the masking procedure comprises concealing the sensitive information of the prone data by replacing the sensitive information with one or more symbols.
